(19) United States
(12) Patent Application Publication
(10) Pub. No.: US 2018/0253801 A1
(43) Pub. Date: Sep. 6, 2018

(54) DISCIPLINING INTERACTION AMONG USERS OF A SOCIAL NETWORK

(71) Applicant: Mark Joseph Nejmeh, Bradley Beach, NJ (US)

(72) Inventor: Mark Joseph Nejmeh, Bradley Beach, NJ (US)

(21) Appl. No.: 15/871,424

(22) Filed: Jan. 15, 2018

Related U.S. Application Data
(60) Provisional application No. 62/466,678, filed on Mar. 3, 2017.

(51) Int. Cl. G06Q 50/00; G06F 21/10; G06Q 20/10; G06Q 20/12

(52) U.S. Cl. CPC G06Q 50/01; G06F 21/10; H04L 67/306; G06Q 20/12; G06Q 20/10

(57) ABSTRACT

A method of managing interactions in a social network is provided. The method segregates user accounts into first and second profiles, and then conditions the visibility of the content of the second profile through a disciplining modality. The discipling modality limits the form of the accessible content of the first profile, thereby incentivizing users to engage in meaningful transactions to access the locked content of the second profile. The present invention provides a transactional modality facilitating transactional approaches by users in their attempt to access the second profile. The number accepted transactional approaches are counted so that upon surpassing a predetermined number of acceptances, the method selectively enables access to the content of the second profile.

### CROSS-REFERENCE TO RELATED APPLICATION

This application claims the benefit of priority of U.S. provisional application No. 62/466,678, filed 3 Mar. 2017, the contents of which are herein incorporated by reference.

### BACKGROUND OF THE INVENTION

The present invention relates to social networking and, more particularly, to a method of disciplining interactions among users of a social network environment by, in certain embodiments, providing steps for moving from first tier interactions to second tier interactions, thereby controlling the user-generated content that is accessible and as a corollary controlling the user-generated content delivered.

Conventional approaches to facilitating sharing of user-generated content include various information sharing technologies or communication platforms such as social networking websites. Such websites may include, be linked with, or provide a platform for applications enabling users to view “profile” pages created or customized by other users where visibility and interaction with such profiles by other users is governed by a set of rules.

The conventional set of rules, however, make worthwhile interaction difficult in the instant-gratification and superficial world of the present day. Most often communicators offer graphical information without audio presentation or without a disciplined transactional approach for controlling the interactions of users trying to connect. For each user, as a result of the flood of attention-grabbing content, the process becomes very distracting. And when wading through this deluge, human nature draws people to superficial attractions, thereby users miss the best choice in this flood of subpar choices. Users get fatigued and make the interaction a task instead of just passive enjoyment of collecting information and entertainment. Furthermore, other platforms do not blend advertising, entertainment and other information outside of the intent of communication.

As can be seen, there is a need for a method of disciplining interactions among users of a social network environment by, in certain embodiments, providing steps for moving from first tier interactions to second tier interactions, thereby controlling the user-generated content that is accessible and as a corollary controlling the user-generated content delivered.

The present invention provides tiered profiles, having at least a first (insensitive, instantly accessible) tier and a second (sensitive, locked) tier. The present invention uses a disciplining algorithm that limits the amount and form of the user-generated content associated with the first tier and counts meaningful first-tier transactions between users, wherein after a predetermined threshold of meaningful first-tier transactions have been met, prior to visibility and interaction with the second-tier user-generated content, which is subsequently unlocked and enabled. First-tier communicators receive notice when the present invention unlocks the communicating user's sensitive user-generated content associated with the second tier. The present application also has a method for the user to bypass the algorithm by allowing a user to disengage the algorithm manually. Thereby, from the get-go the present invention eliminates the boredom of reviewing a deluge of general-consumption content that burdens conventional social networking systems, and then upon unlocking second-tier profiles the present invention delivers continuous user-generated content of matched second-tier users.

The present invention may control first-tier user interactions by charging a fee, deterring users from continuous spamming other users, increasing the quality of the data available before visibility and interaction with the second tier is unlocked, and thereby saving users the precious value of time.

The present invention may also discipline or limit the form and amount of first-tier interactions in order to further control the delivery of content as well as establish more meaningful second-tier matches; for example, the present invention may limit delivery of first-tier interactions to audio files message and certain characteristic visual or entertainment-related content. The audio may have relational information, such as life-long traits and self esteem indicators, that facilitates second-tier matching, while the visual or graphical content may provide meaningful gestures or entertaining informative content based on authors' and consumers' areas of interest and preferences. The present invention further facilitates match-making by enabling certain first-tier content to exchange electronic gifts, such as digital art or digital certificates redeemable in the form of physical gifts. The users are stimulated and, when the counted meaningful transactions meet or exceed a predetermined threshold, the users become second-tier matches capable of potentially unlimited interactions and access to user-generated content. Or users can choose to bypass the algorithm and open everyone to second-tier access.

### SUMMARY OF THE INVENTION

In one aspect of the present invention, a method of managing interactions between users of an online social network includes segregating a profile of each user into a first content and a second content; locking the second content from the remaining users until a predetermined threshold is met; obtaining a first set of rules that define the predetermined threshold as a function of transactional approaches and acceptance of said transactional approaches; providing a transactional modality for generating a plurality of transactional approaches of said user from one or more of the remaining users; and generating a determination that the predetermined threshold has been met by evaluating the plurality of transactional approaches against the first set of rules.

In another aspect of the present invention, the method of managing interactions between users of an online social network includes segregating a profile of each user into a first content and a second content; locking the second content from the remaining users until a predetermined threshold is met; obtaining a first set of rules that define the predetermined threshold as a function of transactional approaches and acceptance of said transactional approaches, wherein the first set of rules imposes a fee for each generated transactional approach; providing a transactional modality for generating a plurality of transactional approaches of said user from one or more of the remaining users; and generating a determination that the predetermined threshold has been met by evaluating the plurality of transactional approaches against the first set of rules, wherein the first content comprising an audio introduction limited to relational information or life-long traits of said user, and wherein the form of the transactional approaches comprises electronic gifts.

These and other features, aspects and advantages of the present invention will become better understood with reference to the following drawings, description and claims.

### BRIEF DESCRIPTION OF THE DRAWINGS

FIG. 1 is a schematic view of an exemplary embodiment of the present invention, illustrating computing devices, site access and data distribution;

FIG. 2 is a schematic view of an exemplary embodiment of the present invention, illustrating user interaction with searching, voice evaluation, entertainment and gifting;

FIG. 3 is a schematic view of an exemplary embodiment of the present invention, illustrating the process of gifting and user acceptance or rejection;

FIG. 4 is a schematic view of an exemplary embodiment of the present invention, may be a continuation from FIG. 3, illustrating the method of managing private messages with restrictions regarding the matching process;

FIG. 5 is a schematic view of an exemplary embodiment of the present invention, illustrating publishing process and distribution process for published and unpublished digital art for e-gifting, as well as acceptance or rejection thereof;

FIG. 6 is a schematic view of an exemplary embodiment of the present invention, illustrating distribution and processing of user gifting tangible items to another user showing acceptance or rejection;

FIG. 7 is a schematic view of an exemplary embodiment of the present invention, a continuation from FIG. 3, illustrating the process and interaction with the database with users communicating in efforts to unlock one another's locked second-tier user-generated content, as well as acceptance or rejection by another user; and

FIG. 8 is a schematic view of an exemplary embodiment of a completed loop of the present invention, illustrating the process of submitting recorded and printed content for viewing and listening by users.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an entertaining collaboration between users in a social network, wherein each user account is segregated between first and second profiles. Visibility of the content of the second profile is controlled by an algorithm that monitors specific, measured interactions between the user of the first profile and other users. The form of the first content is limited to audio introductions and characteristic visual content. The present invention provides a transactional modality facilitating transactional approaches by the other user, such transactional approaches are also limited in form. The accepted transactional approaches are counted so that upon surpassing a predetermined number of acceptances enables the other user access to the second content of the second profile.

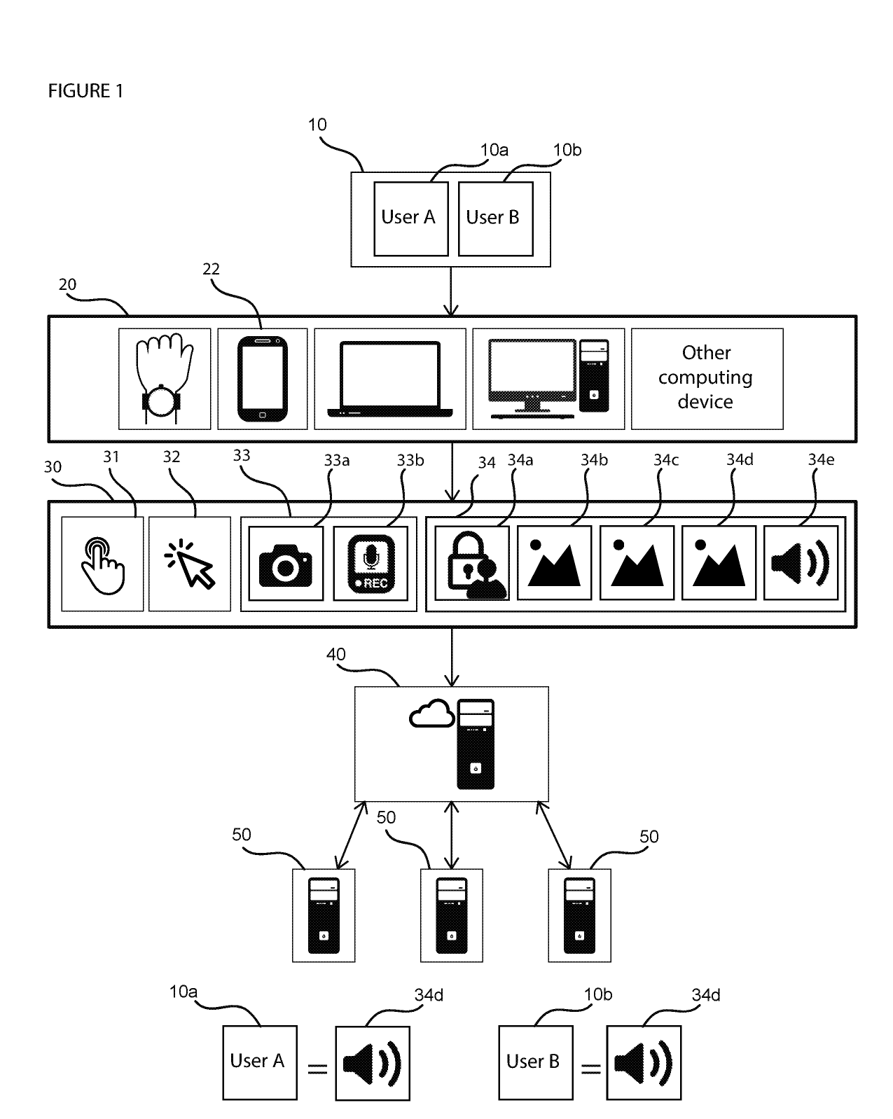

Referring to FIGS. 1 through 8, the present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The system and method embodied in the present invention makes communicating for the purpose of connecting easier through the application of a disciplining algorithm adapted to discipline a user to initially listen to a person's voice and view system-limited, first-tier, user-generated content from another unmatched user. The system also facilitates the matching of users by allowing the gifting of digital art and original, creative works. Most communication platform applications focus on the superficial aspects and provide too much information and choices. The system of the present invention requires a threshold of meaningful transactions to be met as a condition for second-tiered communication of sensitive user-generated content between User A and User B. In simple terms, User A is disciplined to evaluate the voice and other audio output of User B as well as other relevant characteristics of meaningful content of User B, wherein meaningful content is adapted to trigger psychological rationalization. The system allows for User B to e-gift User A to meet said threshold, influencing courting decisions as well as to stimulate a less obvious interest in tastes.

Referring to FIG. 1, Users A and B 10a and 10b may interact with the present invention using one or more computing devices (mobile phone, computer etc.). Users 10 activate to open computing devices 20, 22 and access input/output peripherals 30-33b, such as cameras or microphones, to upload visual and audio output 34-34e of defined content (i.e., feet, hand, legs) such as voice recording 34d to a server 40.

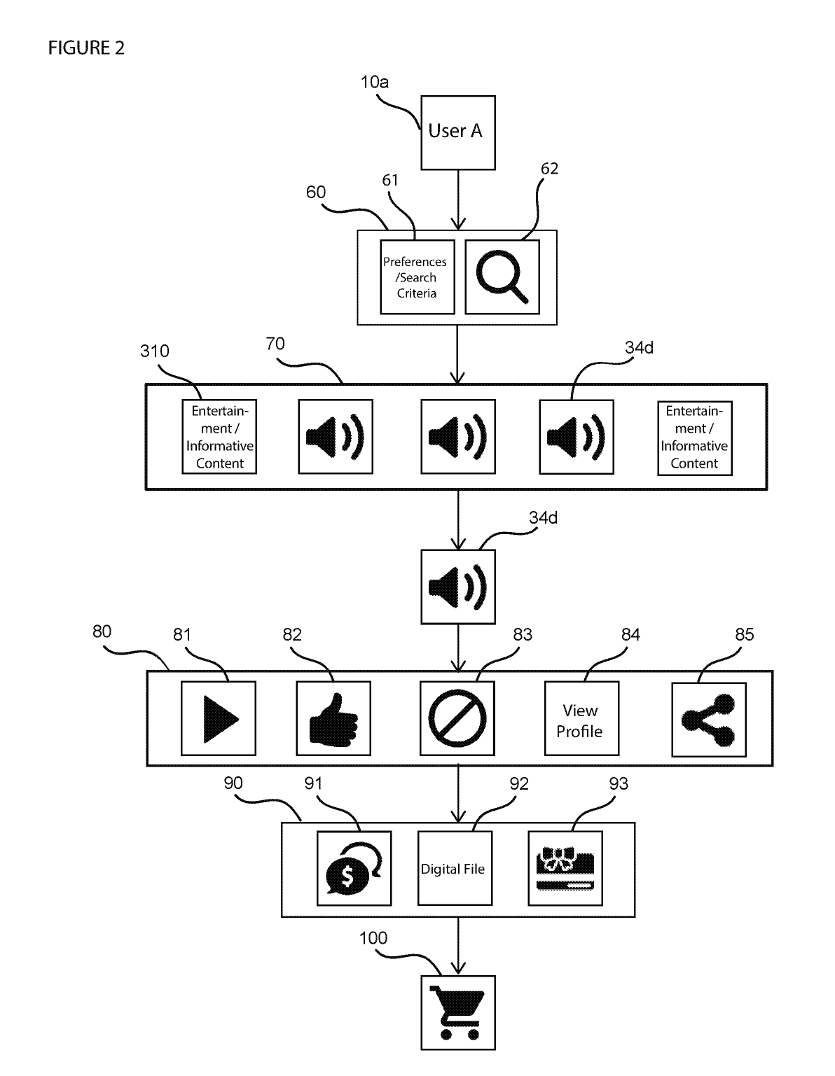

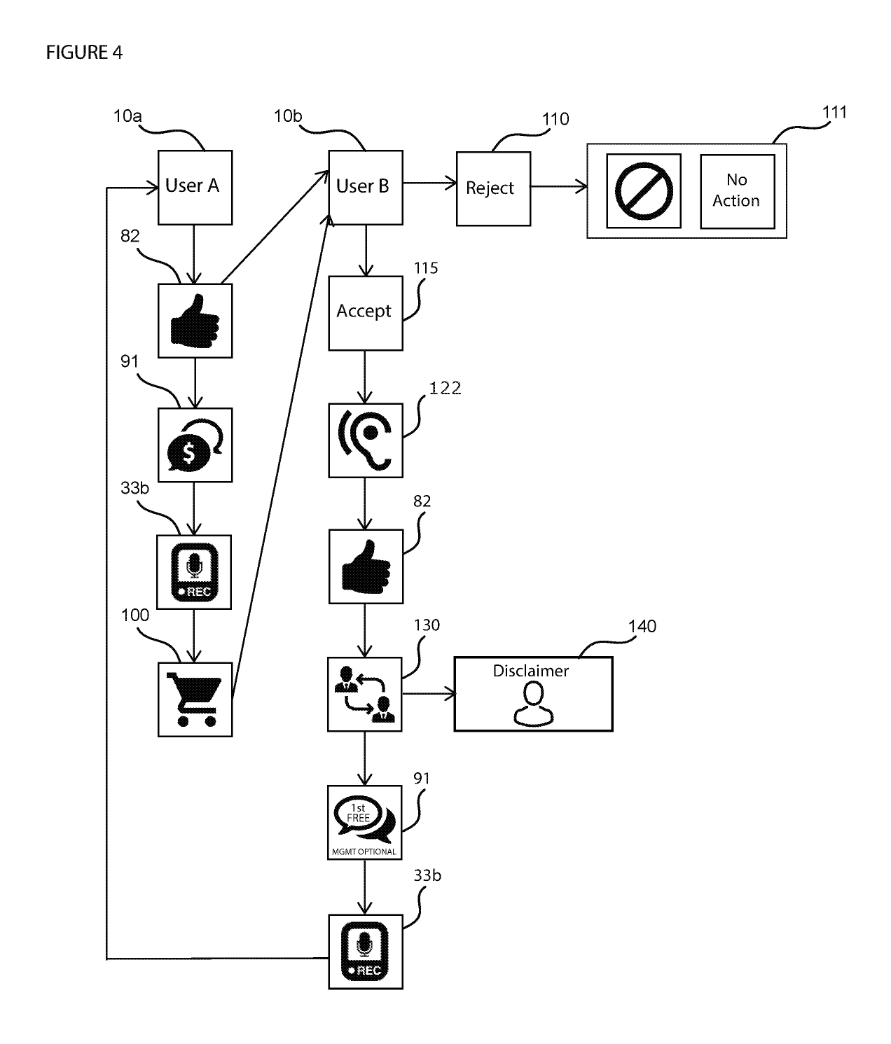

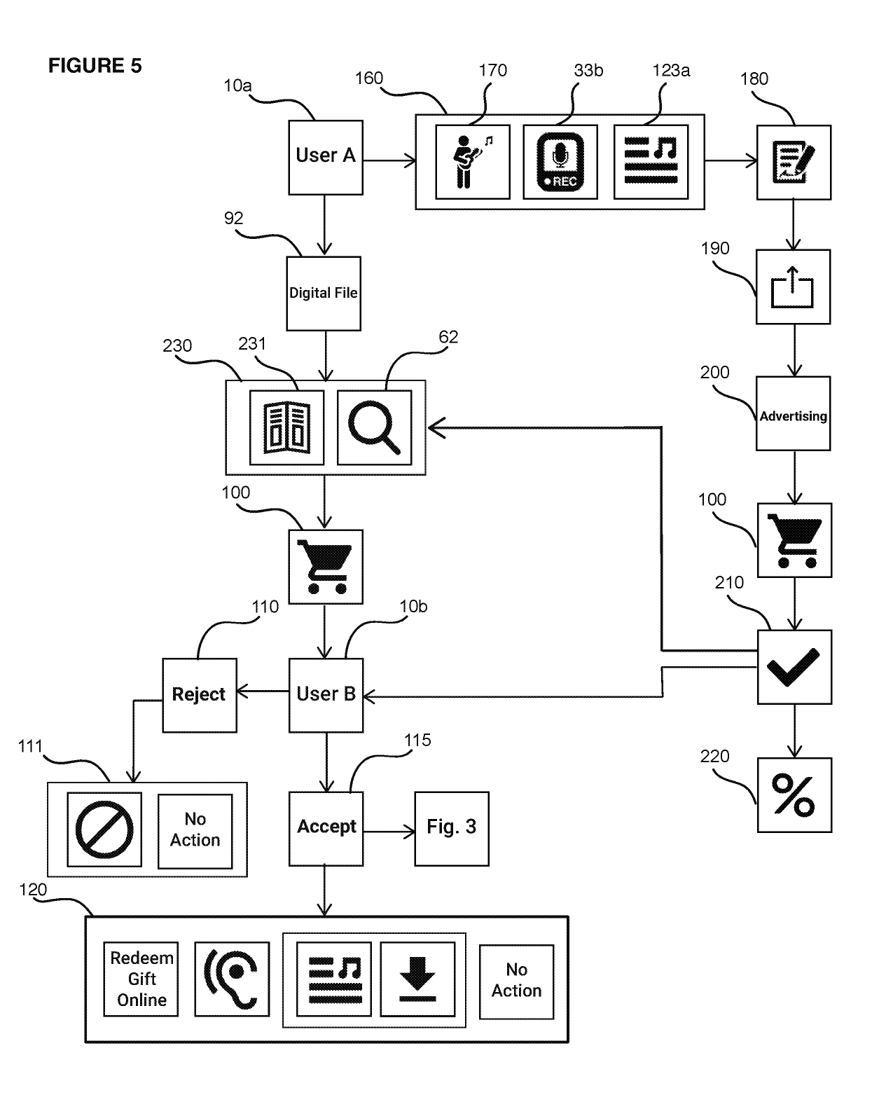

Referring to FIG. 2, once a user 10 completes upload of all media, they can utilize preference/search modalities 60, 61, 62 and output modalities 70 to search, browse, listen to voice recordings 34d and user-generated content of other users 10. Utilizing networking modalities 80, User A has the option to like 82 the profile 84 and voice of User B, block 83, view 81 or share 85 their profile. Viewing User B's profile, through the transaction modality 90, User A can send, for a fee 91, transactional output 92, such as a private recorded message or if management has set an option to send a message free (see FIG. 4), digital file, music, book, movie (See FIG. 5) or an electronic gift 93 to be redeemed at a physical location 260.

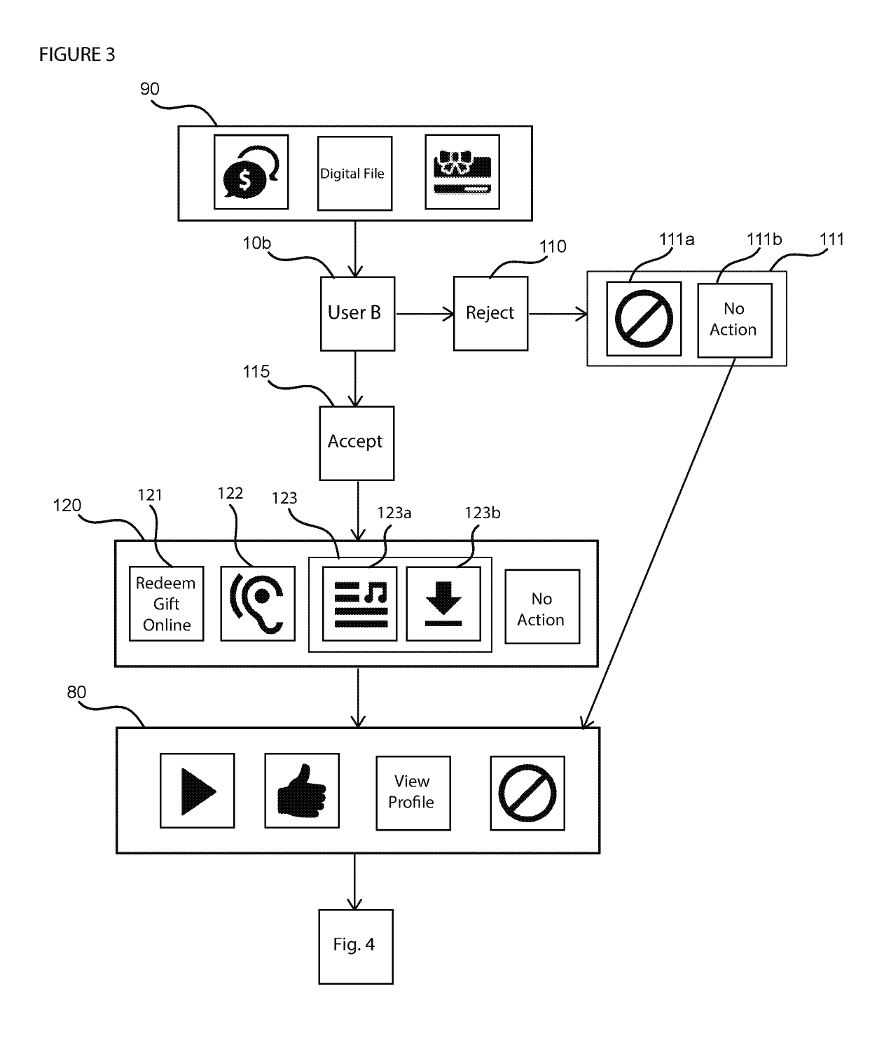

Referring to FIGS. 3 and 4, illustrating the process of gifting and user acceptance or rejection through the transaction modality 90. In the instant example, if User A engages a transaction 10 with User B, User A may be charged a fee 91. The system has an option to allow a free message once users are matched. User B may trigger a rejection 110, whereby no actions 111, 111a, or 111b are initiated, or acceptance 115. Upon acceptance 115, User B may utilize the visibility modality 120 to apply gift redemption functionality 121, output functionality 122, 123, and 123a, download functionality 123b, or no action to receive a private recorded message or digital gift 93 so that User B can listen, download music or redeem online if another form of digital art. User B can listen to User A's voice recording 34d, like them, view their profile or block them. User B can also engage in one-on-one chat 130 conditioned on a disclaimer 140 in accordance with the present invention as herein disclosed.

Referring to FIG. 5, illustrating publishing and distribution process for for e-gifting, through a recordation modality 160, which includes digital music publishing 170. The recordation modality 160 may be coupled with contract authorization 180, uploading capability 190, and advertising functionality 200 before becoming a transaction 100 adapted for a review modality 210 regarding meeting predetermined criteria 220. The present invention may also include document attachment functionality 230 for attaching relevant, searchable published content 231. Digital art will be available for purchase for users to browse and gift to users to gain their romantic interest.

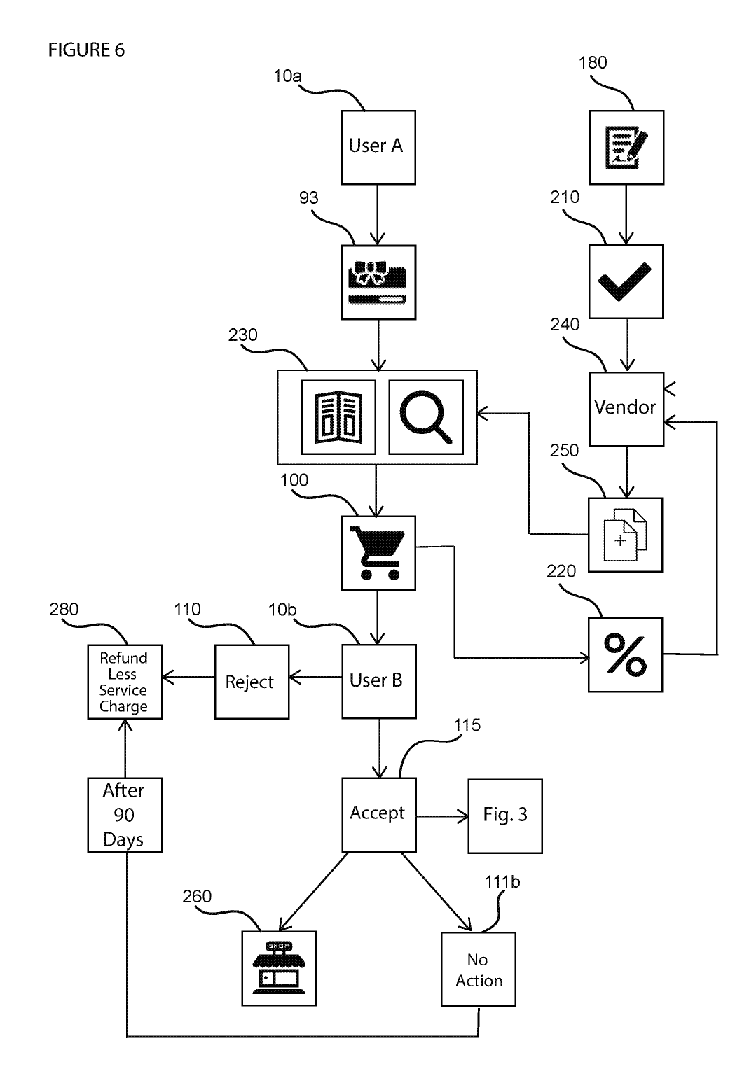

Referring to FIG. 6, third-party vendors 240 making their product available for gifting, or merging 250 with user-generated gifts, will register and accept commission structure (280) so as to upload products and their descriptions, whereby Users may be linked to the vendor's platform 260 upon acceptance.

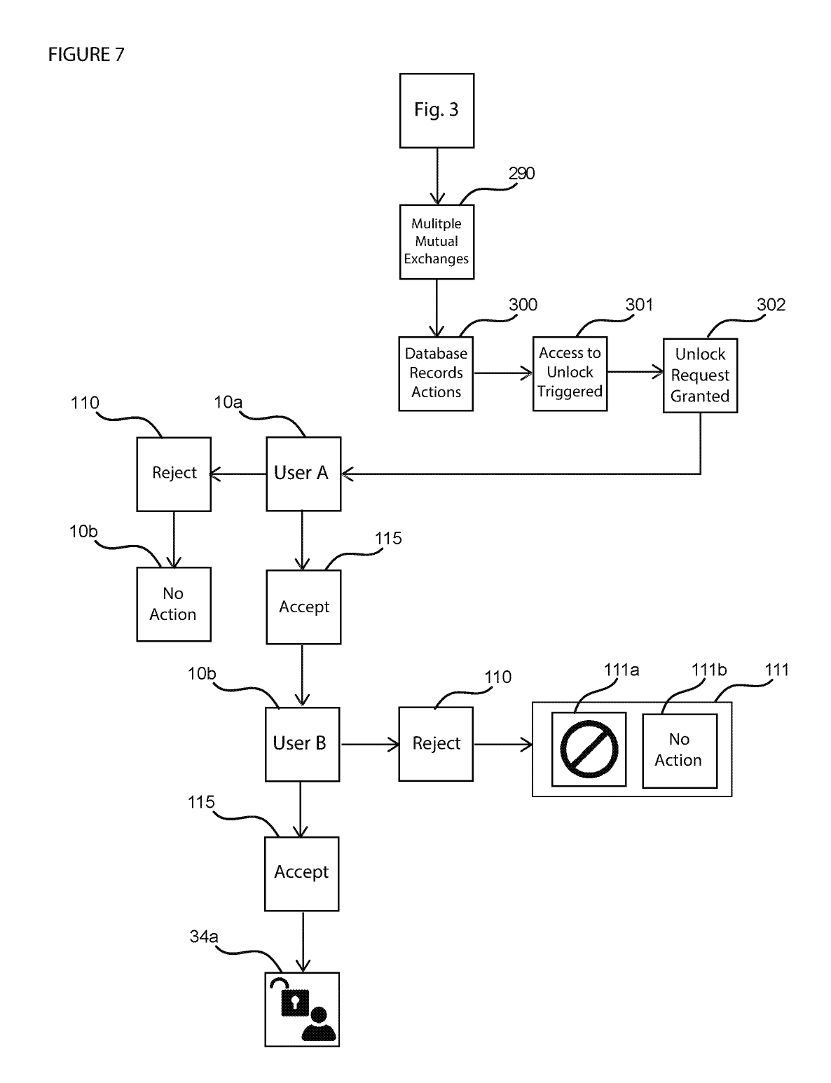

Referring to FIG. 7, illustrating the process and interaction with the database 300 with users communicating in efforts to unlock one another's locked second-tier user-generated content, as well as acceptance or rejection by another user. Specifically, once User A and User B have exchanged the minimum amount 290 of transactions 100 (messages, gifts and/or songs, for example) with one another, the discipling algorithm 300 is configured to grant access/visibility 301 to tier-two content will receive a notification that their locked tier-two content, such as profile photo 34a can now be unlocked through a granted request 302.

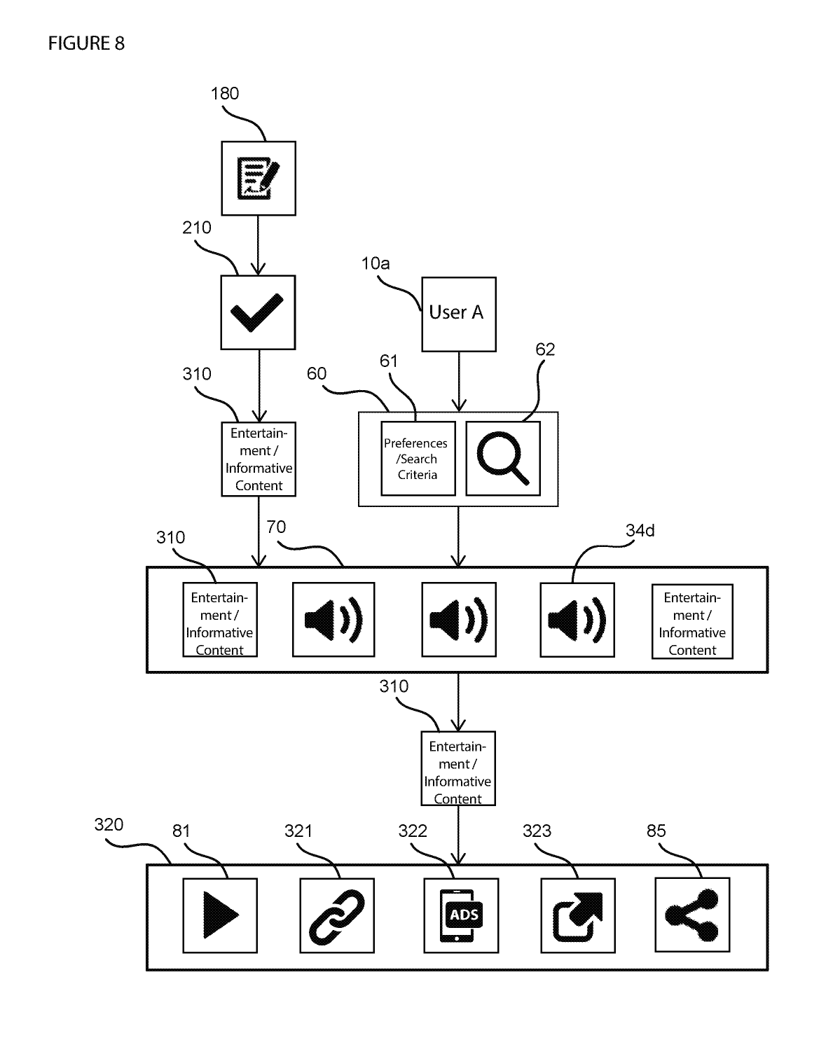

Referring to FIG. 8, illustrating the process of submitting recorded and printed content for viewing and listening by users once tier-two content 310 has been unlocked. Users can also use this application for entertainment with recorded or printed tier-two content 310, serving as points of interest for fostering a meaningful matched set of interactions. A matched modality 320 may be provided by the present invention to link 321 Users A and B tier-two content 310, share 85, jointly upload 323 and/or bundled with advertisements 322. The system can be turned on or off depending on if management wants to offer a free message or not. User B can send a private message for a fee 191. If User A and User B like each other and they have not sent a private message the present invention may be adapted to notified them that they are a match. A user may also instantly allow access. If accepted, the photo 34a will be unlocked to that user only. This system and method can also be used for gaming of any sort or to measure trust.

### How the Invention Works:

Systems and methods embodied in the present invention provide for communicating and making a personal or business connection through software adapted to calculate requisite triggers and tasks and provide the user with the useful user experience and deliver qualified connections. The system presents audio files with content that is intended to be used for attracting a connection. The software collects and serves recorded content to and from participating users. All users record their preferences. A database retrievably stores preferences and serves potential connections based on similar preferences and requested connection preferences. The system serves connection results both aurally and visually. The audio and visual experience blends interesting content and advertising into the stream of audio introductions. Through the use of mouse, keyboard, or mobile device action the user may listen, skip, or view deeper information on the audio presenter. The user may also click on graphics above the play button for other information from advertiser, entertainment, or general information. The user may like or be liked by another user. The user may send a gift of digital content or a tangible item. The user's content is divided into two categories, instant accessible and accessible after a transaction or a number of transactions. The user may bypass the system algorithm and unlock the content on a user by user basis or to all. Once the system's prescribed transaction count has been achieved, or the user initiates an unlock for the user or all users, the restricted content is unlocked by the system. The user may choose to unlock their content to the prospective connection. The user has control of the access to their content on a user-by-user basis only after a selected number of transactions have been accepted. The computer acts as a central processing hub for this activity, taking input from keyboard, audio device, camera, etc. and storing in a database. The user may freely communicate with any user where transaction counts have been achieved between the two users. Once User A and User B have exchanged a certain number of messages, gifts and/or songs with one another, the database counts the actions. The count triggers a change in status of open or close of the access lock to the profile photo 34a.

A method of using the present invention may include the following. Users 10 would use the present invention to find a connection. Users 10 would focus on the voice and preferences that appeal to the listening user. Interactions would include further private messages and or gifting. Users have the opportunity to form an opinion from gestures and perceived personality without initial superficial attraction. Users can also use this application for entertainment with recorded or printed content serving as points of interest.

Additionally, the present invention could be used as a motivational instrument and or in the workforce, for polling, reviewing or anywhere when team selection, compatibility or information is needed. It could also be applied to education and deliver a new method of learning for the easily distracted student. It could be used as an advertising tool on other websites and mobile environments. For example, the present invention could be adapted to produce educational tool like an audio flash card, advertisement tool on any sidebar, political presentation and polling device, audio greeting card (get well soon, etc.)

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention

It should be understood, of course, that the foregoing relates to exemplary embodiments of the invention and that modifications may be made without departing from the spirit and scope of the invention as set forth in the following claims.

What is claimed is:

1. A method of managing interactions between users of an online social network, comprising:
segregating a profile of each user into a first content and a second content;
locking the second content from the remaining users until a predetermined threshold is met;
obtaining a first set of rules that define the predetermined threshold as a function of transactional approaches and acceptance of said transactional approaches;
providing a transactional modality for generating a plurality of transactional approaches of said user from one or more of the remaining users; and
generating a determination that the predetermined threshold has been met by evaluating the plurality of transactional approaches against the first set of rules.

2. The method of claim 1, wherein the first set of rules imposes a fee for each generated transactional approach.

3. The method of claim 1, wherein the first content comprising an audio introduction.

4. The method of claim 1, wherein audio output of the first content is limited to an audio introduction.

5. The method of claim 3, wherein the audio introduction is limited to relational information or life-long traits of said user.

6. The method of claim 4, wherein the audio introduction is limited to relational information or life-long traits of said user.

7. The method of claim 3, wherein the first content further compromises visual output limited to gestures of said user.

8. The method of claim 7, wherein the first content further compromises a recording of said user providing preferences.

9. The method of claim 1, wherein the form of the transactional approaches comprises electronic gifts.

10. The method of claim 1, wherein the form of the transactional approaches is limited to direct messaging and electronic gifts.

11. A method of managing interactions between users of an online social network, comprising:
segregating a profile of each user into a first content and a second content;
locking the second content from the remaining users until a predetermined threshold is met;
obtaining a first set of rules that define the predetermined threshold as a function of transactional approaches and acceptance of said transactional approaches, wherein the first set of rules imposes a fee for each generated transactional approach;
providing a transactional modality for generating a plurality of transactional approaches of said user from one or more of the remaining users; and
generating a determination that the predetermined threshold has been met by evaluating the plurality of transactional approaches against the first set of rules,
wherein the first content comprising an audio introduction limited to relational information or life-long traits of said user, and
wherein the form of the transactional approaches comprises electronic gifts.
